(19) United States
(12) Patent Application Publication
(10) Pub. No.: US 2017/0239757 A1
(43) Pub. Date: Aug. 24, 2017

(54) BRAZING GAP SPACING APPARATUS AND METHOD

(71) Applicant: Siemens Energy, Inc., Orlando, FL (US)

(72) Inventor: Gerald J. Bruck, Titusville, FL (US)

(21) Appl. No.: 15/049,283

(22) Filed: Feb. 22, 2016

(51) Int. Cl. B23K 35/02; B23K 1/00; B23K 3/08

(52) U.S. Cl. CPC B23K 35/0233; B23K 3/08; B23K 1/0016

(57) ABSTRACT

A screen (24A-H) of a specified thickness (T) for insertion in a gap (32) between surfaces of workpieces (32, 34) to be joined by brazing. The screen thickness determines and maintains the gap thickness during brazing. The screen has a higher melting point than the braze filler material (22), is wettable by a melt of the braze filler material, and may have a higher tensile strength than the braze filler material at operating temperatures of the braze joint. The screen may include electrical resistance heating wires (52, 62) to melt the filler material (46). The screen may be covered by the filler material, forming a brazing foil (20B). The screen may include electrically conductive insulated wires (92, 93) connected to a sensor (95) such as a thermocouple or strain gauge to monitor a condition of the braze joint during subsequent operation.

### FIELD OF THE INVENTION

The invention relates generally to the field of brazing, and more specifically to maintaining a specified gap between two surfaces while they are being joined by brazing.

### BACKGROUND OF THE INVENTION

Gap control in brazing influences properties and quality of the resulting joint. A known chart by Lucas-Milhaupt Inc. is shown in FIG. 10. Tensile strength of a braze joint generally decreases with increasing joint thickness, but many factors affect the relationship. A properly gapped braze joint may be stronger in tension than the braze alloy itself. Explanations for this include: a) Hard faces of adjoining material limit slip along crystallographic planes in the braze; and b) Stretching of the braze under tension must be accompanied by lateral reduction in area, however such lateral reduction is restrained by closely spaced and relatively strong adjoining material. As the joint thickness increases, such lateral restraint becomes less effective and tensile strength decreases toward that of the braze alloy.

Sometimes a decrease in tensile strength is also found toward the left of the apex 19 of the curve of FIG. 10 at smaller joint gap thickness. Prior explanations for this include: a) Some brazing processes require flux to clean oxides from the parent materials and to thereby provide good wetting and capillary action of the molten braze. Too small of a gap provides insufficient flux to dissolve oxide films; b) Some brazing processes are done in a reducing atmosphere such as in hydrogen. The hydrogen reacts with metal oxides on the surfaces to produce water. The concentration of water vapor in the immediate vicinity of the surfaces determines if vapor is produced or if oxide is left (or reformed). Very small joint gaps prevent the ingress of reducing gas and egress of vapor; c) Some metals are partially dissolved by some braze alloys. When this occurs the braze alloy melting point may increase to the point of solidification at brazing temperature. With very small joint gaps with limited braze material, this condition is reached quickly. This can prevent flow of braze across the entire joint resulting in incomplete brazing and poor tensile strength.

Braze joint clearances recommended by researchers such as M. H. Sloboda are typically less than 0.267 mm (0.011 in.), and usually at least 0.051 mm (0.002 in.), or 0.025 mm (0.001 in.), depending on the materials of the braze and the workpiece. Precise joint gap control is important to ensure oxide removal, promotion of wetting, and promotion of capillary-driven coverage of the joint. This ensures good strength of the braze joint and, for certain applications, leak tightness of the braze joint.

Thus, a need exists for precision and consistency in braze gap control. One existing method is to tack weld at select locations prior to brazing to hold the parts at a desired gap clearance. However, tack welding causes local distortion of the parts and can result in a varied gap across the braze plane of a large part. This is especially common when previous tacks in a sequence cause gap changes that are then frozen in place by subsequent tacks. Tack welds also leave localized oxides that are difficult to remove, especially in the immediate vicinity of the tack. Another existing method is to use fixtures, including dead weights placed on the part. However, during brazing, the molten braze may be compressed by such fixturing, changing the gap width. For some precisely machined parts, a surface finish may provide reasonable gap control, but capillary action of the braze melt must reach, penetrate and wet all gap surfaces including contact locations. A further complication arises when parts having different coefficients of thermal expansion are brazed, which complicates gap maintenance during the brazing process.

### BRIEF DESCRIPTION OF THE DRAWINGS

The invention is explained in the following description in view of the drawings that show:

FIG. 1 is an isometric view of a brazing foil including a gap-setting screen, illustrating aspects of an embodiment of the invention.

FIG. 2 is an isometric view of the brazing foil of FIG. 1 inserted between opposed surfaces to be brazed.

FIG. 3 is an isometric view of an embodiment with a single longitudinal wire.

FIG. 4 is a front sectional view of a brazing screen with overlapping wires in a brazing gap with molten brazing filler.

FIG. 5 is a front sectional view of a brazing screen with electrically insulated resistance heating wires in a brazing gap with molten brazing filler.

FIG. 6 is a front sectional view of a brazing screen with longitudinal electrically insulated resistance heating wires in a brazing gap with molten brazing filler.

FIG. 7 is a top schematic view of a brazing foil having a screen with resistance heating wires connected between electrical terminals.

FIG. 8 is a top schematic view of a brazing foil having a screen with resistance heating wires connected at one end to a power supply, and grounded at the other end.

FIG. 9 is a top schematic view of a brazing foil having a screen providing electrical connection to a mid-joint sensor element.

FIG. 10 is a known chart of brazing joint thickness versus joint tensile strength.

### DETAILED DESCRIPTION OF THE INVENTION

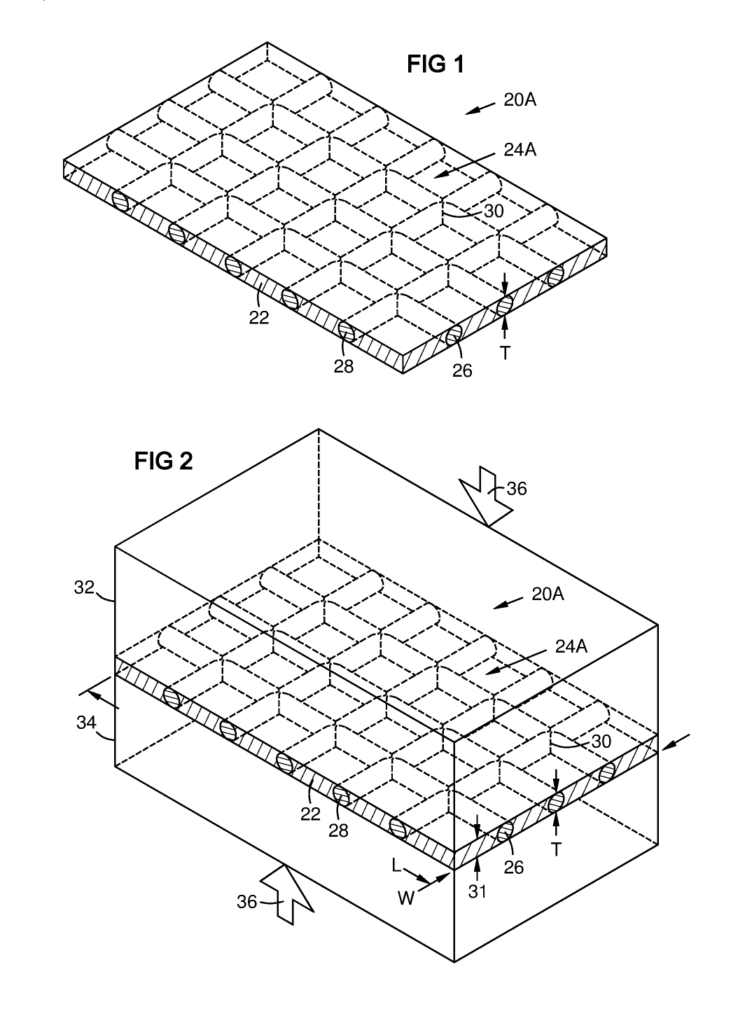

FIG. 1 illustrates a brazing foil 20A having a brazing filler material 22 with an embedded open mesh screen 24A made of one or more longitudinal wires 26 that intersect 30 one or more transverse wires 28. The wires have a higher melting point than the brazing filler material 22, so the thickness T of the screen sets and maintains a predetermined gap between the opposed surfaces being brazed. Examples of wire materials suitable for very high temperature brazing include tungsten (mp 3422° C.), rhenium (mp 3180° C.), tantalum (mp 2996° C.), molybdenum (mp 2620° C.), ceramics, and refractory alloys. Examples of materials suitable for moderate temperature brazing include nickel, nickel alloys, stainless steel, cobalt alloys and iron alloys. The wire material may be the same as the material of the part(s) being brazed. The thickness of the screen is the thickness of the intersections 30, which in this embodiment may be the thickness of a single wire 26, 28 or of the thickest wire 26, 28 if they have different thicknesses. Alternately, the wires may overlap at the intersections, as later shown, making the screen thickness the sum of thicknesses of the overlapping wires at the intersections. Herein, the term “intersection” includes wires crossing through the same space as in FIG. 1 and wires crossing each other with physical contact and overlap as in FIG. 4, unless the term is narrowed by further description for a given embodiment.

FIG. 2 illustrates the brazing foil 20A inserted in a gap 31 between opposed surfaces of two workpieces 32, 34 to be brazed, for example in an oven. During heating, the workpieces may be urged together 36 to close the gap 31 down to the screen thickness T during melting of the braze filler 22. The gap 31 and the foil 20A have a length L and a width W for descriptive purposes herein. Most brazed joints are designed for shear loading, and the wires 26, 28 of the foil 10A can provide strengthening of the braze under shear loading, functioning somewhat like rebar in concrete.

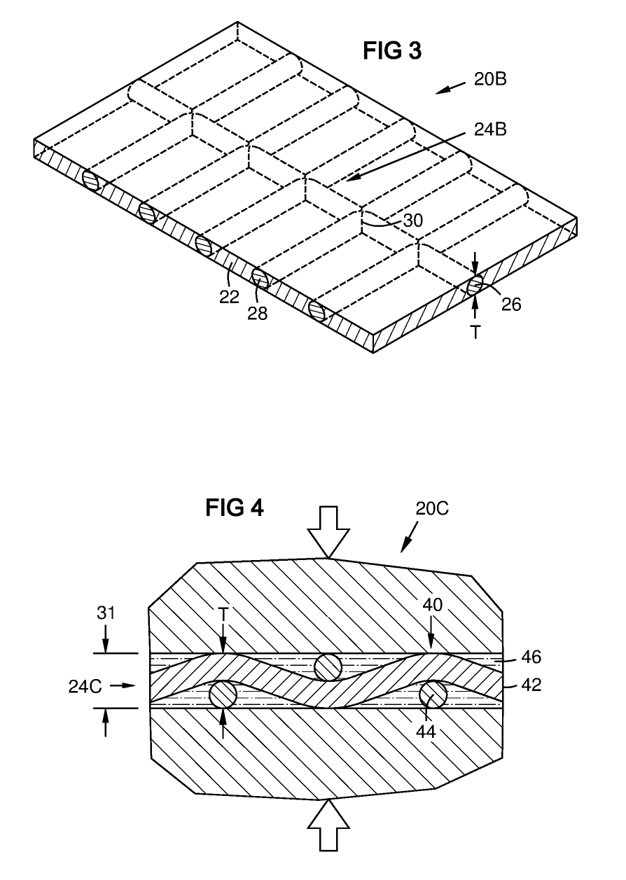

FIG. 3 shows an embodiment of a brazing foil 20B with an embedded screen 24B having a wire arrangement that allows the filler material 22 to expand within and laterally beyond the gap during melting without the constraint of intervening longitudinal wires. This screen has only one longitudinal wire 26, and multiple transverse wires 28 that intersect the longitudinal wire. Other embodiments may include only transverse wires 28 in a region where a braze joint is to be formed, with one or more longitudinal wires 26 interconnecting the transverse wires 28 being located in a region away from where the braze joint is to be formed, thereby providing mechanical support for the transverse wires 28 which function to control the gap size, while still allowing unencumbered flow and expansion of the filler material 22 in a direction parallel to the transverse wires 28 in the region where the braze joint is formed. Thus, the term “screen” as used herein includes an array of wires held together such that at least a portion of some of the wires can be inserted into a region of a braze joint for the purpose of controlling a gap of the braze joint. The term “screen” should not be interpreted so broadly herein to encompass random filaments or non-interconnected rodlets (small wire portions).

FIG. 4 is a front sectional view of an embodiment of a brazing foil 20C with a screen 24C having intersecting longitudinal 42 and transverse 44 wires that lap each other at the intersections 40. The foil 20C is inserted in a brazing gap 31. The wires may interleave over-under each other longitudinally and transversely, for example in a plain weave pattern. Alternately, the longitudinal wires may be bent as shown, and the transverse wires may be straight. The screen thickness T is the sum of the thicknesses of two overlapping wires at each intersection. All intersections 40 within the gap 31 may have the same thickness T, or only a subset of the wires may be thicker to determine the gap 31. Overlapping wires allow molten filler material 46 to flow across the width of the brazing gap by capillary action, since the bent wires 42 provide flow space as shown. Such a brazing screen 24C may be provided separately from the filler material. Filler material 46 may be melted and infused from a side of the gap after the screen is in place. Alternately the foil 20C may be formed as a preform including both the screen 24C and filler material 46 spanning across the screen 24C. For example, the screen 24C may be embedded in the filler material 46, or the screen 24C be pressed onto a foil of the filer material 46, or the screen 24C may be filled with a paste of the filler material 46.

FIG. 5 is a front sectional view of an embodiment of a brazing foil 20D with a screen 24D having longitudinal 52 and transverse 54 wires that overlap at the intersections 51. The wires may be coated with refractory electrical insulation 56 such as silica, hafnium oxide, magnesia, or alumina, allowing the wires to serve as resistance heating elements. For example, the longitudinal wires 52 may be made of tungsten arranged for connection between electrical terminals, as later shown. Tungsten is a resistance heating material used in filaments of incandescent light bulbs. It has a high melting point (3422° C.), low coefficient of thermal expansion, and high tensile strength. Incandescent bulb filaments commonly have an uncoiled length of over 20 inches (580 mm). In this embodiment 20D the wires 52 may be coated with insulation after forming the screen 24D, allowing the longitudinal and transverse wires 52, 54 to contact each other at the intersections. This facilitates heat conduction from the longitudinal heating wires to the transverse wires. The screen thickness T is the sum of the thicknesses of two overlapping wires at each intersection, including the thickness of the insulation material.

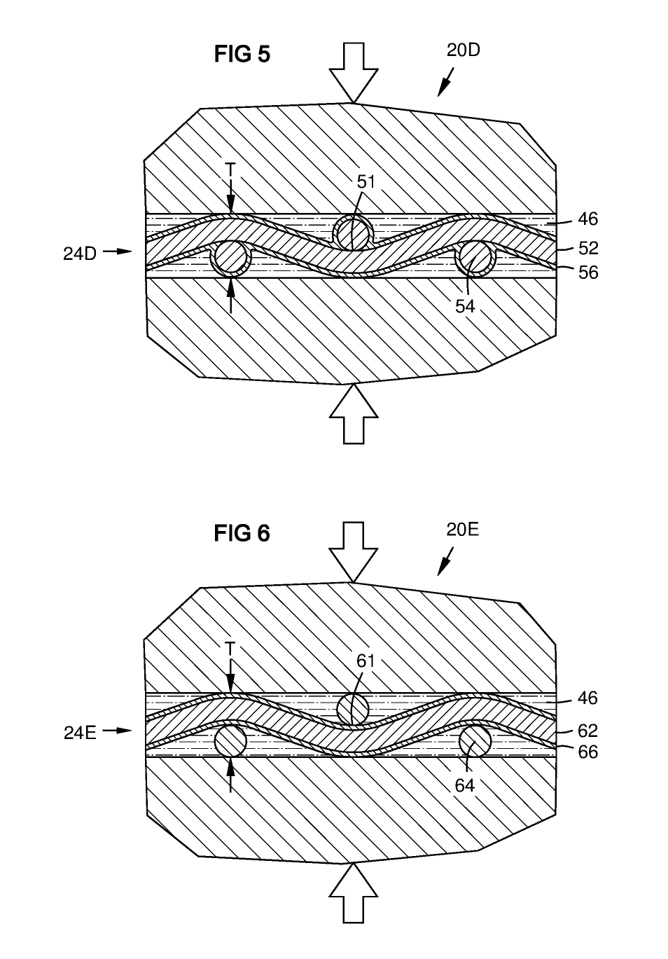

FIG. 6 is a front sectional view of an embodiment of a brazing foil 20E with a screen 24E having longitudinal 62 and transverse wires 64 that overlap at the intersections 61. The screen thickness T is the sum of thicknesses of two overlapping wires at each intersection. The longitudinal wires may be coated with electrical insulation 66, allowing them to serve as resistance heating elements. In this embodiment the longitudinal wires 62 may be coated with insulation before forming the screen 24E, thus separating them electrically from the transverse wires. The transverse wires 64 may also be coated before forming the screen, or they may be non-insulated, as shown.

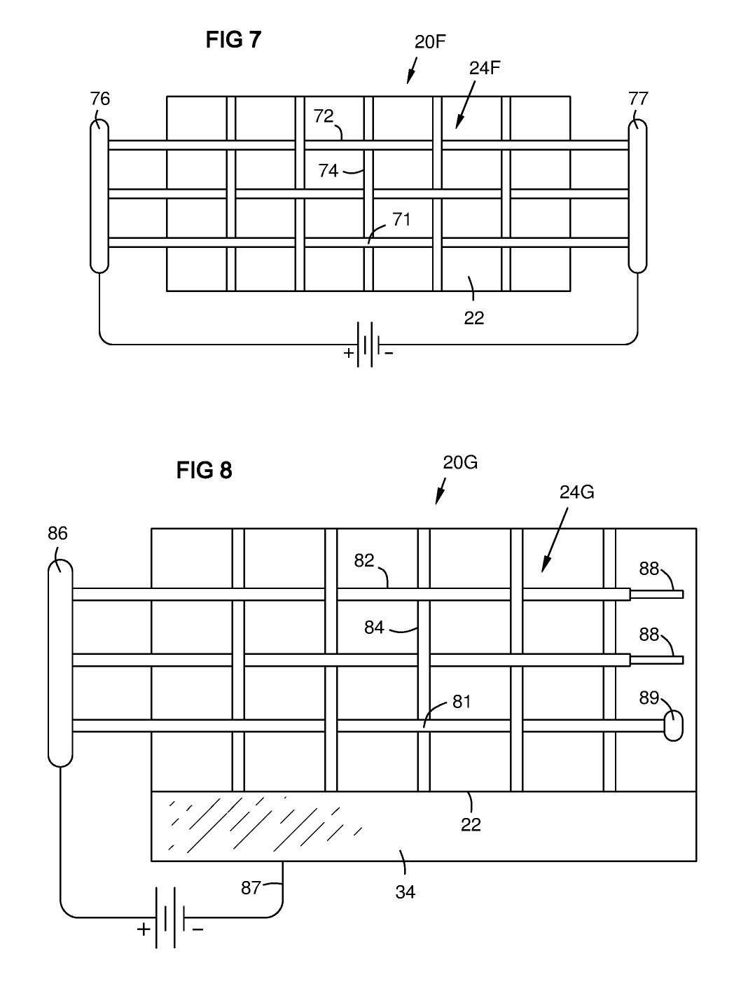

FIG. 7 is a top schematic top view of an embodiment of a brazing foil 20F with a brazing screen 24F formed of longitudinal 72 and transverse 74 wires. Some or all of the wires 72 are electrically insulated resistance heating wires connected between electrical terminals 76, 77. The terminals 76, 77 may be formed integrally with the ends of the longitudinal wires 72, or may be attached thereto, such as with clamps.

FIG. 8 is a top schematic view of an embodiment of a brazing foil 20G with a brazing screen 24G formed of longitudinal 82 and transverse 84 wires. Some or all of the wires 82 are electrically insulated resistance heating wires connected to an electrical terminal 86 at one end. These wires lack insulation at the second end for electrical connection to the workpiece 34 via electrically conductive filler 22, completing a circuit to a terminal 87 connected to the workpiece. If the filler is not sufficiently electrically conductive, contacts 89 may be formed on the ends of the wires 82 with the thickness of the gap to contact the workpieces directly when the workpieces are urged together. Alternatively, the second end(s) may be spot welded to the workpiece 34 for electrical connection. Alternate to spot welds a filler such as copper based epoxy could accomplish electrical contacts 89 on the ends of the wires 82 within the thickness of the gap to contact the workpieces directly. These embodiments are especially useful where access to opposed sides of the workpiece is unavailable or limited, but they can be used in any situation in which one or both workpieces is/are electrically conductive.

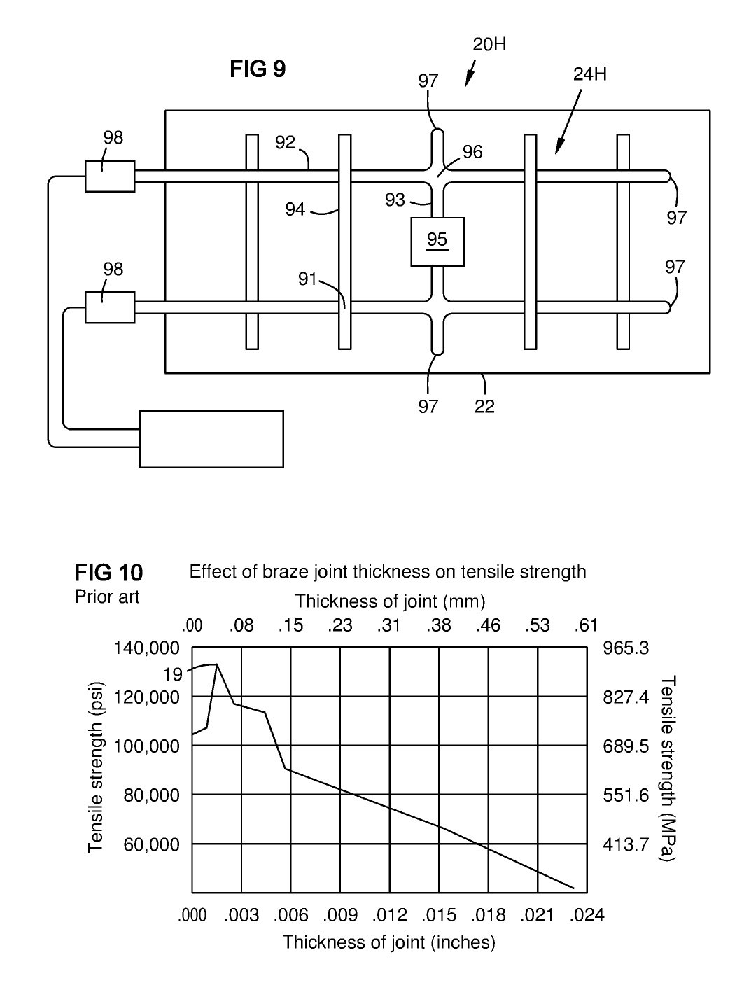

FIG. 9 is a top schematic view of an embodiment of a brazing foil 20H with a brazing screen 24H formed of longitudinal 92 and transverse 93, 94 wires. At least one of the wires may be electrically conductive and insulated and connected to a mid-joint sensor 95 such as a thermocouple or strain gauge that indicates a condition of the brazing within the braze joint, either during the brazing operation or upon later operation of the brazed component. High temperature thermocouples are available, for example, made of tungsten/rhenium or platinum/rhodium with insulation of hafnium oxide, magnesia, or alumina. These can be used in temperatures up to 2315° C. (4200° F.). At least some intersections 96 may be electrically continuous to provide a conductive path 92, 93 from the sensor 95 in a middle part of the foil to connections 98 outside the filler material 22. If these connection wires 92, 93 have free ends within the foil, they may be capped 97 with electrical insulation to block electrical continuity with the brazing. Alternately, an electrical grounding path may be provided through the brazing and workpiece. Other embodiments may utilize fiber optic filaments to facilitate communication with a fiber optic sensor or to deliver laser energy for heat. The fiber optic filaments may function as wires of the screen to define the braze gap, or they may be used with larger metal wires which define the gap while the fiber optic filaments function only for signal communication or energy transfer. As shown in this figure, some or all of the wires of any foil embodiment do not necessarily extend to the edges of the foil filler material 22.

FIG. 10 is a known chart of brazing joint thickness versus joint tensile strength, and illustrates the importance of precise joint thickness control. Such control is provided by the screens of the present invention.

While various embodiments of the present invention have been shown and described herein, it will be obvious that such embodiments are provided by way of example only. Numerous variations, changes and substitutions may be made without departing from the invention herein. For example, the illustrated embodiments have longitudinal and transverse wires disposed at right angles to each other, however, any appropriate relative wire orientation may be used. Accordingly, it is intended that the invention be limited only by the spirit and scope of the appended claims.

1. A brazing apparatus comprising:
a screen comprising an array of wires at least partially inserted between two opposed surfaces to be joined by brazing, wherein a thickness of the screen maintains a pre-determined gap size between the two opposed surfaces during the brazing to form a brazed joint; and
wherein the screen comprises multiple intersections of wires made of a material with a higher melting temperature than a melting temperature of brazing filler material used for the brazing.

2. The apparatus of claim 1, wherein each of the multiple intersections comprises a crossing of two of the wires that overlap and are in physical contact with each other at the crossing, and wherein said predetermined gap size is the sum of the thicknesses of the two overlapping wires.

3. The apparatus of claim 1, wherein the screen comprises longitudinal wires interlaced with transverse wires in a plain weave pattern.

4. The apparatus of claim 1, wherein the screen comprises an array of transverse wires in a region of the brazed joint and at least one longitudinal wire joining the transverse wires together.

5. The apparatus of claim 4, wherein the longitudinal wire is located in the region of the brazed joint.

6. The apparatus of claim 1, wherein the screen is spanned by the brazing filler material to form a brazing foil prior to the brazing.

7. The apparatus of claim 6, wherein at least a portion of the wires is electrical resistance heating wire with a coating of electrical insulation, each electrical resistance heating wire providing at least one electrical contact outside the brazing filler material of the foil.

8. The apparatus of claim 6, wherein the screen comprises intersections between electrically conductive, insulation-coated longitudinal and transverse wires, and at least some of said intersections are electrically continuous between the intersecting longitudinal and transverse wire but are insulated from the filler material.

9. The apparatus of claim 6, wherein the screen comprises longitudinal and transverse wires relative to a length of the foil, at least one longitudinal wire is electrically insulated resistance heating wire comprising first and second electrical contacts at respective first and second ends of the wire extending outside the brazing filler material of the foil.

10. The apparatus of claim 6, wherein the screen comprises longitudinal and transverse wires relative to a length of the foil, at least one longitudinal wire is electrically insulated resistance heating wire comprising a first electrical contact at a first end of the wire extending outside the brazing filler material of the foil and a second electrical contact at a second end of the wire inside the brazing filler material of the foil.

11. The apparatus of claim 6, further comprising a sensor in the foil for sensing a condition of the brazed joint, wherein at least one of the wires of the screen electrically connects the sensor to a contact outside the brazing filler material of the foil.

12. The apparatus of claim 6, wherein the screen comprises a single longitudinal wire intersected by a plurality of transverse wires along a length of the foil.

13. The apparatus of claim 6, further comprising a fiber optic filament disposed within the foil.

14. A brazing apparatus comprising:
an array of wires; and
a braze filler material spanning at least a portion of the array of wires, the braze filler material having a lower melting temperature than the array of wires.

15. The apparatus of claim 14, wherein the array of wires comprises at least one longitudinal wire intersecting a plurality of transverse wires at intersections; and
wherein all of the wire intersections have substantially a same thickness, and said thickness maintains a predetermined a gap thickness between the two opposed surfaces during the formation of a braze joint.

16. The apparatus of claim 14, wherein the array of wires comprises an electrically insulated resistance heating wire.

17. A method of brazing comprising:
placing a screen in a gap between two workpieces to be joined, wherein the screen has a predetermined thickness;
melting a brazing filler material to fill the gap and the screen in the gap;
urging the two workpieces together during the melting step to close the gap to the thickness of the screen; and
cooling the brazing filler material to form a braze joint between the workpieces.

18. The method of claim 17, further comprising forming the screen and the filler material into a braze foil preform prior to the step of placing.

19. The method of claim 18, further comprising pressing the screen and a filler material foil together to form the braze foil preform.

20. The method of claim 18, further comprising spreading a paste of the brazing filler material across the screen prior to the step of placing.
